(19) United States
(12) Patent Application Publication
(10) Pub. No.: US 2025/0073745 A1
(43) Pub. Date: Mar. 6, 2025

(54) BATTERY ELECTRODE MATERIAL APPLICATION DEVICE

(71) Applicant: TOYOTA JIDOSHA KABUSHIKI KAISHA, Toyota-shi (JP)

(72) Inventors: Masashi UEDA, Toyota-shi (JP); Tomoko HIGO, Toyota-shi (JP); Shinji KOJIMA, Nagoya-shi (JP)

(73) Assignee: TOYOTA JIDOSHA KABUSHIKI KAISHA, Toyota-shi (JP)

(21) Appl. No.: 18/679,524

(22) Filed: May 31, 2024

(30) Foreign Application Priority Data
Sep. 4, 2023 (JP) 2023-143060

(51) Int. Cl. B05C 19/00; B05C 19/06; H01M 4/04

(52) U.S. Cl. CPC B05C 19/008; B05C 19/06; H01M 4/0402

(57) ABSTRACT

The battery electrode material application device includes a conveyance unit that transports a conductive base material, a hopper configured to accommodate powder, a conductive screen disposed between the base material transported by the conveyance unit and the hopper, a voltage application unit that can apply a voltage between the conveyance unit and the screen, and an inclined plate that extends obliquely downward from the screen.

### CROSS-REFERENCE TO RELATED APPLICATION

This application claims priority to Japanese Patent Application No. 2023-143060 filed on Sep. 4, 2023, incorporated herein by reference in its entirety.

### BACKGROUND

### 1. Technical Field

The present disclosure relates to a battery electrode material application device.

### 2. Description of Related Art

Japanese Unexamined Patent Application Publication No. 7-109031 (JP 7-109031 A) discloses a powder and granular material supply device in which a screen is disposed under a hopper. In the device disclosed in JP 7-109031 A, in particular, a plurality of vibrating plates is provided inside the hopper below the screen. The device has a structure in which vibration is uniformly applied to a powder and granular material in the hopper, as an ultrasonic transducer is attached to a vibration connecting rod that connects the vibrating plates.

### SUMMARY

In the device described in JP 7-109031 A, however, there is a possibility that powder cannot be uniformly applied to an application target object, as the powder comes into contact with the vibration connecting rod before being discharged.

An object of the present disclosure is to obtain a battery electrode material application device that can uniformly apply powder to an application target object.

A first aspect provides a battery electrode material application device including:
a conveyance unit that conveys a conductive base material;
a hopper configured to be able to accommodate powder;
a conductive screen disposed between the base material conveyed by the conveyance unit and the hopper;
a voltage application unit capable of applying a voltage between the conveyance unit and the screen; and an inclined plate that extends obliquely downward from the screen.

In the battery electrode material application device according to the first aspect, the conductive base material is conveyed by the conveyance unit. In addition, the hopper is configured to be able to store powder. Further, a conductive screen is disposed between the base material conveyed by the conveyance unit and the hopper. A voltage can be applied between the conveyance unit and the screen by the voltage application unit. As a result, a predetermined amount of powder is supplied from the hopper via the screen to the base material conveyed by the conveyance unit, whereby the powder is applied to the base material. Here, the inclined plate extends obliquely downward from the screen. As a result, the powder having passed through the screen is dispersed in the process of sliding on the inclined plate, and the powder can be uniformly applied to the base material.

A second aspect provides the battery electrode material application device according to the first aspect, in which the inclined plate extends to a vicinity of the base material conveyed by the conveyance unit.

In the battery electrode material application device according to the second aspect, the inclined plate extends to the vicinity of the base material, and therefore it is possible to suppress the powder falling from the inclined plate to be scattered.

A third aspect provides the battery electrode material application device according to the first aspect, in which a plurality of inclined plates is provided along a conveyance direction of the base material.

In the battery electrode material application device according to the third aspect, a plurality of inclined plates is provided, and therefore the powder can be uniformly applied to the base material even when the screen has a long length.

A fourth aspect provides the battery electrode material application device according to the first aspect, in which the inclined plate is set at an angle of 45 degrees or more and 80 degrees or less with respect to the screen.

In the battery electrode material application device according to the fourth aspect, it is possible to suppress the powder staying on the inclined plate by setting the inclined plate at an angle of 45 degrees or more with respect to the screen, as compared with when the inclination angle is less than 45 degrees. In addition, it is possible to suppress the powder falling without contacting the inclined plate by setting the inclined plate at an angle of 80 degrees or less with respect to the screen, as compared with when the inclination angle is more than 80 degrees.

A fifth aspect provides the battery electrode material application device according to any one of the first to fourth aspects, in which: a frame body that holds the screen is provided below the hopper; and an ultrasonic transducer is connected to a side wall of the frame body.

In the battery electrode material application device according to the fifth aspect, a frame body that holds the screen is provided below the hopper. An ultrasonic transducer is connected to a side wall of the frame body, and therefore ultrasonic vibration can be applied to the powder passing through the screen.

With the battery electrode material application device according to the present disclosure, as has been described above, powder can be uniformly applied to an application target object.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an overall configuration of a battery electrode material application device according to an embodiment;

FIG. 2 is a view schematically showing an entire configuration of a battery electrode material application device according to a modification; and

FIG. 3 is a diagram schematically showing an overall configuration of a battery electrode material application device according to a comparative example.

### DETAILED DESCRIPTION OF EMBODIMENTS

A battery electrode material application device 10 according to an embodiment will be described with reference to the drawings.

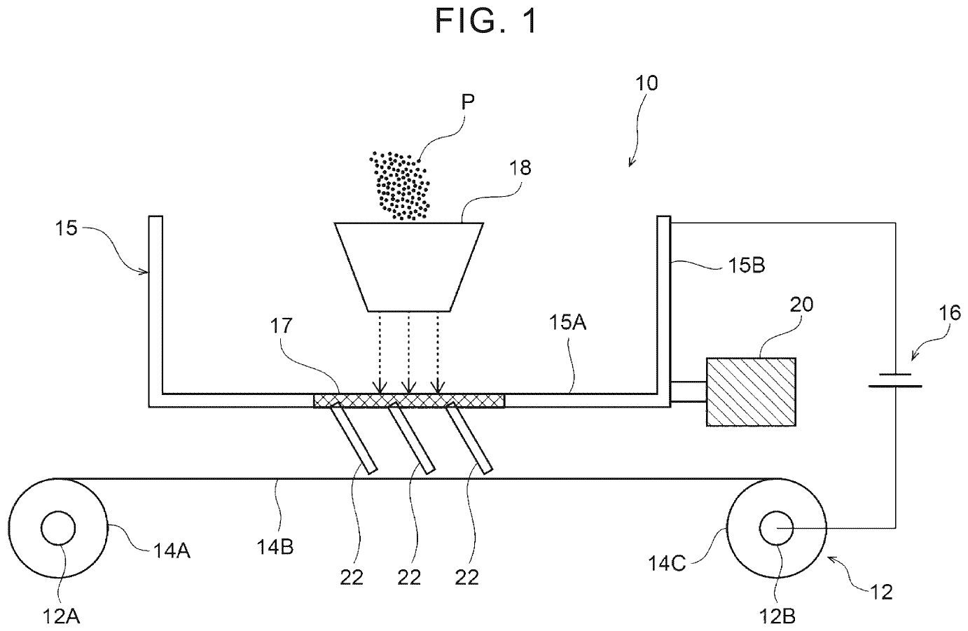

FIG. 1 is a diagram schematically showing an overall configuration of a battery electrode material application device 10 according to the present embodiment. As shown in FIG. 1, a battery electrode material application device 10 according to the present embodiment is a coater for manufacturing an electrode plate of a battery. The battery electrode material application device 10 includes a conveyance unit 12, a frame body 15, a screen 17, a hopper 18, a power supply 16 serving as a voltage application unit, an ultrasonic transducer 20, and an inclined plate 22.

The conveyance unit 12 includes a supply-side roller 12A and a recovery-side roller 12B, and each of the supply-side roller 12A and the recovery-side roller 12B is configured to rotate when a motor (not shown) is operated.

A conductive base material 14 is wound between the supply-side roller 12A and the recovery-side roller 12B. As the base material 14, a metal foil or the like is used, and for example, a copper foil, an aluminum foil, or the like is used in a state of being wound in a roll shape.

The supply-side roller 12A is wound with a pre-coating base material 14A before the powder is applied in a roll shape, and the recovery-side roller 12B is wound with a post-coating base material 14C after the powder is applied in a roll shape. By operating a motor (not shown), the supply-side roller 12A and the recovery-side roller 12B rotate, and the base material 14 is conveyed from the supply-side roller 12A to the recovery-side roller 12B. Then, the powder P is applied to the base material 14B being conveyed during conveyance between the supply-side roller 12A and the recovery-side roller 12B.

A frame body 15 is provided above the base material 14B during conveyance. The frame body 15 includes a bottom-wall 15A and a side-wall 15B and is formed in a substantially box shape, and an upper portion thereof is opened. Further, a screen 17 is held on the bottom-wall 15A of the frame body 15, and the screen 17 is positioned below the hopper 18, which will be described later. In other words, the screen 17 is disposed between the base material 14 conveyed by the conveyance unit 12 and the hopper 18.

The screen 17 has conductivity, and a predetermined pattern is formed. For example, the screen 17 may be a conductive screen in which portions of the pattern are formed of a mesh material. The powder P is applied on the base material 14 through the screen 17, whereby the powder P is applied on the base material 14 in a desired pattern.

The mesh material of the screen 17 is not particularly limited as long as it is electrically conductive. For example, a wire rod such as stainless steel containing iron as a main component, galvanized iron, brass, or copper may be used. The size of the mesh is not particularly limited, and may be appropriately changed according to the pattern.

A hopper 18 is disposed above the screen 17. The upper and lower end portions of the hopper 18 are each opened, and are formed in a shape that gradually narrows toward the lower side. Further, the hopper 18 of the present embodiment is arranged in a longitudinal direction perpendicular to the conveyance direction of the base material 14 by the conveyance unit 12. That is, the hopper 18 is disposed with the depth direction of the paper surface in FIG. 1 as the longitudinal direction. For example, the longitudinal length of the hopper 18 may be slightly shorter than the width of the base material 14 to be transported.

The powder P is supplied from a supply hole at an upper end portion of the hopper 18. As the powder P, an active material and a binder constituting an electrode material are used. For example, in the case of a negative electrode material of a lithium ion battery, a composite material of graphite as an active material and a binder is used as the powder P. The binder may be, for example, at least one material selected from polyvinylidene fluoride (PVDF), vinylidene fluoride-hexafluoropropylene copolymer (PVDF-HEP), styrene-butadiene rubber (SBR), carboxymethyl cellulose (CMC), polyacrylic acid (PAA), polyamideimide (PAI), and polyimide (PI).

Here, the side wall 15B of the frame body 15 and the conveyance unit 12 are electrically connected to the power supply 16, respectively, and the power supply 16 is configured to be able to apply a voltage between the screen 17 and the conveyance unit 12. When the powder passes through the screen 17 in a state where a voltage is applied, the mesh contacts the powder P so that the powder P can be charged.

An ultrasonic transducer 20 is connected to the side wall 15B of the frame body 15. The structure and method of the ultrasonic transducer 20 are not particularly limited as long as the vibrator is capable of applying ultrasonic vibration to the powder in the hopper 18.

In the present embodiment, the ultrasonic transducer 20 is connected to a lower end portion of the side wall 15B of the frame body 15, and is configured to be able to directly apply ultrasonic vibrations to the bottom wall 15A. In addition, the ultrasonic transducer 20 is preferably connected to a central portion in the longitudinal direction of the hopper 18 from the viewpoint of imparting ultrasonic vibration to the powder P accommodated in the hopper 18 without bias.

An inclined plate 22 is attached to the screen 17. The inclined plate 22 extends obliquely downward from the lower surface of the screen 17, and in the present embodiment, as an example, is inclined in the conveying direction from the screen 17 toward the base material 14 (downward).

In the present embodiment, as an example, three inclined plates 22 are attached to the screen 17. The three inclined plates 22 are attached at equal intervals along the conveying direction of the base material 14, and extend to the vicinity of the base material 14.

Further, each of the three inclined plates 22 is set at an angle of not less than 45 degrees and not more than 80 degrees with respect to the screen 17. In the present embodiment, as an example, the three inclined plates 22 are set at an angle of 70 degrees with respect to the screen 17. The angle of the inclined plate 22 may be changed according to the material of the powder to be supplied.

### Action

Next, the operation of the battery electrode material application device 10 according to the present embodiment will be described.

In the battery electrode material application device 10 according to the present embodiment, the conductive base material 14 is conveyed by the conveyance unit 12. Further, the hopper 18 is configured to be capable of storing the powder P. Further, a conductive screen 17 is disposed between the base material 14 conveyed by the conveyance unit 12 and the hopper 18. A voltage can be applied between the conveyance unit 12 and the screen 17. As a result, a predetermined amount of the powder P is supplied from the hopper 18 through the screen 17 to the base material 14 conveyed by the conveyance unit 12, so that the powder P is applied to the base material 14.

Further, an inclined plate 22 is attached to the screen 17, and the inclined plate 22 extends obliquely downward from the screen 17. As a result, the powder P having passed through the screen 17 is dispersed in the process of sliding on the inclined plate 22, and the powder P can be uniformly applied to the base material 14.

In particular, in the present embodiment, since the inclined plate 22 extends to the vicinity of the base material 14B during conveyance, it is possible to prevent the powder P dropped from the inclined plate 22 from varying. That is, it is possible to prevent the powder P from being applied unevenly.

Further, in the present embodiment, a plurality of inclined plates 22 are provided along the conveying direction. Therefore, even when the length of the screen 17 is long in the conveyance direction, the powder P can be uniformly applied to the base material 14.

Further, in the present embodiment, the angle of the inclined plate 22 is set at an angle of not less than 45 degrees and not more than 80 degrees with respect to the screen. As a result, it is possible to prevent the powder P from staying on the inclined plate 22 as compared with a case where the inclination angle of the inclined plate 22 is smaller than 45 degrees. That is, as the angle of the inclined plate 22 becomes smaller, the powder P is less likely to slip and stagnate on the inclined plate 22. In the present embodiment, by setting the inclination angle of the inclined plate 22 to 45 degrees or more, the powder can be smoothly slid on the inclined plate 22 regardless of the type of the powder to be applied.

On the other hand, if the angle of the inclined plate 22 with respect to the screen 17 is too large, the powder P may fall from the screen 17 to the base material 14 without contacting the inclined plate. Further, in order to reliably contact the powder P to the inclined plate 22, since it is necessary to narrow the pitch of the adjacent inclined plate 22, the number of inclined plates 22 increases. In the present embodiment, by setting the inclination angle of the inclined plate 22 to 80 degrees or less, it is possible to prevent the powder P from falling without contacting the inclined plate 22.

Further, in the present embodiment, the ultrasonic transducer 20 is connected to the side wall 15B of the frame body 15, and is configured to be able to apply ultrasonic vibrations to the screen 17. Thus, the powder P does not need to be imprinted with a dedicated roller, squeegee, or the like, and can be slid on the inclined plate 22 by passing the screen 17 in a state where the powder P is dispersed.

In particular, in the present embodiment, since the ultrasonic transducer 20 is connected to the lower portion of the side wall 15B of the frame body 15, the ultrasonic transducer can be adjustably applied to the screen 17.

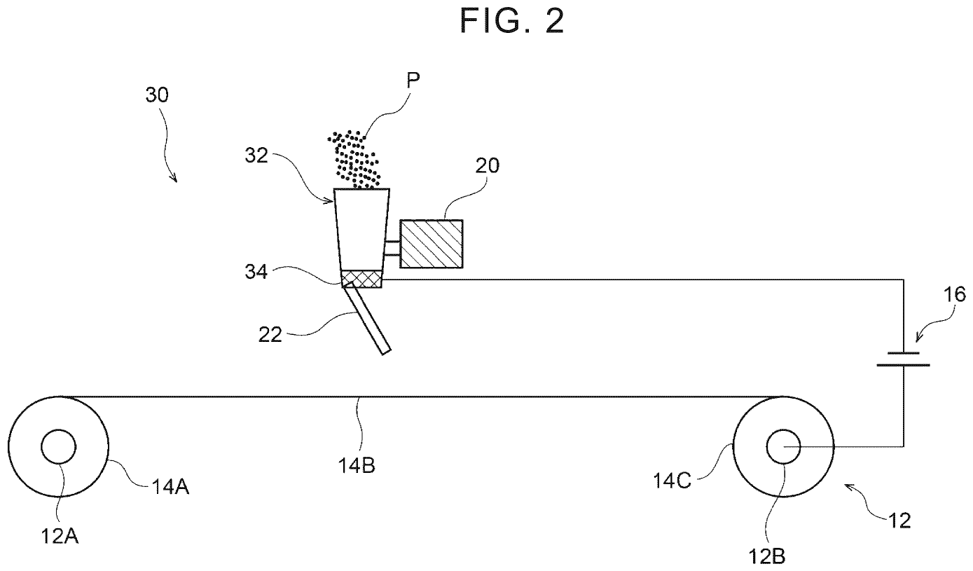

In the present embodiment, a structure in which the screen 17 is held in the frame body 15 is adopted, but the present disclosure is not limited thereto. For example, the structure of the modification shown in FIG. 2 may be adopted.

### Modification

FIG. 2 is a diagram schematically illustrating an overall configuration of a battery electrode material application device 30 according to a modification. As shown in FIG. 2, the battery electrode material application device 30 according to the present modification is different from the embodiment in that the frame body 15 is not provided.

In this variation, a hopper 32 is disposed above the base material 14B during transport. The upper and lower end portions of the hopper 32 are each opened, and are formed in a shape that gradually narrows toward the lower side, and the length along the conveying direction is shorter than that of the hopper 18 of the embodiment.

A screen 34 is provided at a lower end portion of the hopper 32. The screen 34 is attached to the discharge hole of the hopper 32 and is disposed between the base material 14B and the hopper 32 during transportation. Further, an inclined plate 22 is attached to the screen 34, and the inclined plate 22 and the inclined plate 22 extend obliquely downward from the lower surface of the screen 34. In the present embodiment, as an example, the screen 34 is inclined in the conveyance direction toward the base material 14 (downward), and one inclined plate 22 is attached thereto.

An ultrasonic transducer 20 is connected to a side wall of the hopper 32. The ultrasonic transducer 20 is connected to a lower side of a central portion of the side wall of the hopper 32 in the up-down direction.

In the present modification example, since the inclined plate 22 extends downward from the screen 34 as in the embodiment, the powder P that has passed through the screen 34 is dispersed in the process of sliding the inclined plate 22, and the powder P can be uniformly applied to the base material 14.

Hereinafter, the evaluation results of the battery electrode material application device 10 according to the present disclosure and the battery electrode material application device 100 of the comparative example will be described. First, the battery electrode material application device 100 of the comparative example will be described, and thereafter, the evaluation procedure will be described.

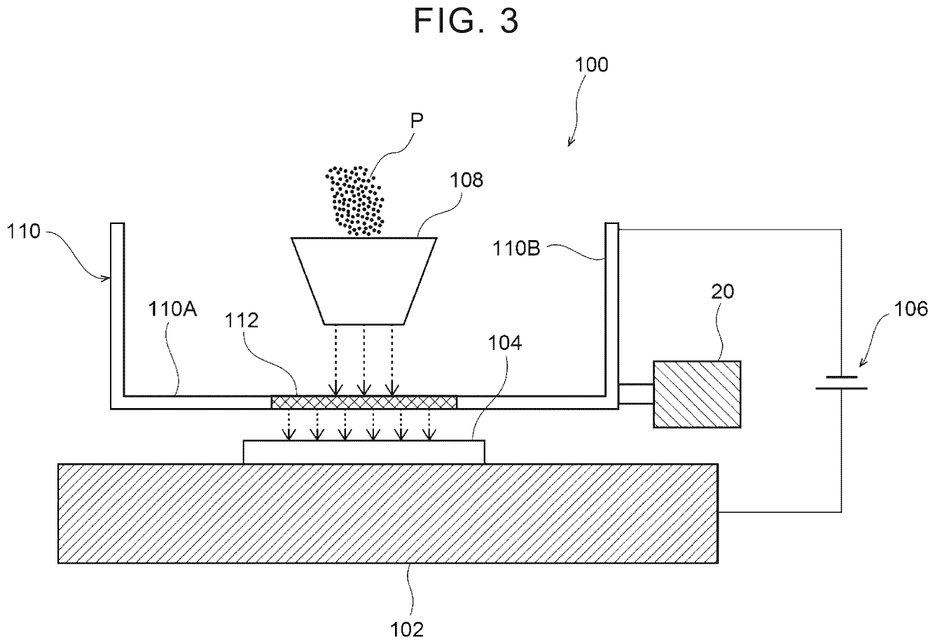

FIG. 3 is a diagram schematically showing an overall configuration of a battery electrode material application device 100 according to a comparative example. As illustrated in FIG. 3, the battery electrode material application device 100 of the comparative example includes a base material holder 102, a hopper 108, a screen 112, a power source 106, and an ultrasonic transducer 20.

In the comparative embodiment, the frame body 110 is disposed below the hopper 108, and the conductive screen 112 is disposed on the bottom-wall 110A of the frame body 110. In the structure of the comparative example, the power source 106 is installed so that a voltage can be applied between the frame body 110 and the base material holder 102.

Further, in the structure of the comparative example, the ultrasonic transducer 20 is connected to the side wall 110B of the frame body 110, and the ultrasonic transducer is applied to the screen 112 via the frame body 110 by applying the ultrasonic transducer to the frame body 110. Here, in the structure of the comparative example, the inclined plate 22 is not provided. Therefore, the powder P supplied from the hopper 108 to the frame body 110 is subjected to ultrasonic vibration when passing through the screen 112, and is applied to the base material 104 placed on the base material holder 102 by dropping as it is.

The evaluation procedure is as follows.

### (1) Composite of Negative Electrode Materials

As powder for coating, graphite and PVDF were put into a MP mixer (manufactured by Nippon Coke Industries Co., Ltd.), and combined treatment was carried out under the conditions of 10000 [rpm] and 2 [min].

The average particle diameter of the graphite was 10-20 [μm]. Further, the composition-ratio of graphite and PVDF was set to 97.5/2.5 [wt %].

### (2) Film Formation

In the battery electrode material application device 10 shown in FIG. 1, the composite-treated powder P was supplied to the hopper 18, and the powder P was applied from the screen 17 set to 300 mesh to the base material 14 at a 100 [mm]×50 [mm]. On the other hand, in the battery electrode material application device 100 shown in FIG. 3, the composite-treated powder P was supplied to the hopper 108, and the powder P was applied from the screen 112 set to 300 mesh to the base material 104 in 100 [mm]×50 [mm] range.

### (3) Fixing and Densification

The powder P is fixed on the base material 14 by pressing at 150 [° C.] and 5 [kN] for 1 minute using a flat press. In the same procedure, the powder P is fixed to the base material 104 to prepare an electrode.

### (4) Measurement of Electrode Weight

The fabricated electrodes were punched in 12 places and weighed by an electronic balance.

Table 1 below calculates the dispersion of the weight of the twelve locations.

TABLE 1

| | Examples | Comparative Example |
|---|---|---|
| Weight Variation [%] | ±5 | ±59 |

From the results shown in Table 1, it can be seen that by applying the battery electrode material application device 10 according to the example, the variation in weight at the time of electrode production can be reduced as compared with the case where the battery electrode material application device 100 according to the comparative example is used. Since the weight of the electrode depends on the amount per unit area of the powder P to be applied, it can be seen that the powder P can be applied more uniformly in the examples than in the comparative examples.

In the present embodiment, as shown in FIG. 1, the ultrasonic transducer 20 is connected to the side wall 15B of the frame body 15, but the present disclosure is not limited thereto, and the ultrasonic transducer 20 may not be provided.

In the present embodiment, the ultrasonic transducer 20 is connected to the lower portion of the side wall 15B of the frame body 15, but the present disclosure is not limited thereto. For example, the ultrasonic transducer 20 may be connected to the vertical center of the side wall 15B.

Furthermore, in the present embodiment, three inclined plates 22 are provided, but the present disclosure is not limited thereto, and the number and the angle of the inclined plates 22 may be changed. For example, the number of inclined plates 22 may be increased, and the screen 17 may be arranged so that adjacent inclined plates 22 overlap when viewed from the vertical direction.

Furthermore, in the present embodiment, the angle of the three inclined plates 22 is the same angle, but the present disclosure is not limited thereto, and the inclination angle may be changed for each inclined plate 22. For example, the angle of the inclined plate 22 far from the side wall 15B to which the ultrasonic transducer 20 is connected may be increased, and the angle of the inclined plate 22 close to the side wall 15B to which the ultrasonic transducer 20 is connected may be decreased. Thus, by adjusting the angle of the inclined plate 22 in accordance with the attenuation of the ultrasonic vibration, it is possible to drop the same amount of the powder P per unit time from all the inclined plates 22.

In addition, in the present embodiment, the conveyance unit 12 includes the supply-side roller 12A and the recovery-side roller 12B, but the present disclosure is not limited thereto, and other structures may be employed as long as the structure can convey the base material 14. For example, in a case where the base material is not in the form of a roll but in the form of a sheet, the base material may be conveyed by a belt or the like.

With respect to the above embodiments, the following supplementary notes are disclosed.

### Appendix 1

A conveyance unit for conveying a conductive base material,
A hopper configured to accommodate powder; A conductive screen disposed between the base material conveyed by the conveyance unit and the hopper,
A voltage application unit capable of applying a voltage between the conveyance unit and the screen,
An inclined plate extending obliquely downward from the screen;
Battery electrode material application device.

### Appendix 2

The battery electrode material application device according to Appendix 1, wherein the inclined plate extends to a vicinity of a base material conveyed by the conveyance unit.

### Appendix 3

The battery electrode material application device according to Appendix 1 or 2, wherein a plurality of the inclined plates is provided along the conveyance direction of the base material.

### Additional Remark 4

The battery electrode material application device according to any one of Appendices 1 to 3, wherein the inclined plate is set at an angle of 45 degrees or more and 80 degrees or less with respect to the screen.

### Appendix 5

A frame body holding the screen is provided below the hopper,
The battery electrode material application device according to any one of Appendices 1 to 4, wherein an ultrasonic transducer is connected to a side wall of the frame body.

What is claimed is:

1. A battery electrode material application device comprising:
a conveyance unit that conveys a conductive base material;
a hopper configured to be able to accommodate powder;
a conductive screen disposed between the base material conveyed by the conveyance unit and the hopper;
a voltage application unit capable of applying a voltage between the conveyance unit and the screen; and
an inclined plate that extends obliquely downward from the screen.

2. The battery electrode material application device according to claim 1, wherein the inclined plate extends to a vicinity of the base material conveyed by the conveyance unit.

3. The battery electrode material application device according to claim 1, wherein a plurality of inclined plates is provided along a conveyance direction of the base material.

4. The battery electrode material application device according to claim 1, wherein the inclined plate is set at an angle of 45 degrees or more and 80 degrees or less with respect to the screen.

5. The battery electrode material application device according to claim 1, wherein:
a frame body that holds the screen is provided below the hopper; and
an ultrasonic transducer is connected to a side wall of the frame body.
